(19) United States
(12) Patent Application Publication
(10) Pub. No.: US 2004/0268156 A1
(43) Pub. Date: Dec. 30, 2004

(54) Sharing system and operation processing method and program therefor

(75) Inventors: Ken Sakakibara, Tokyo (JP); Yoshihisa Tadokoro, Tokyo (JP); Naoko Hyotani, Tokyo (JP); Takashi Miyasaki, Tokyo (JP); Yohei Muto, Tokyo (JP)

Correspondence Address: Canon U.S.A. Inc., Intellectual Property Department, 15975 Alton Parkway, Irvine, CA, 92618-3731, US

(73) Assignee: Canon Kabushiki Kaisha, Tokyo (JP)

(21) Appl. No.: 10/864,023

(22) Filed: Jun. 8, 2004

(30) Foreign Application Priority Data
Jun. 24, 2003 (JP) 2003-179955
Jan. 26, 2004 (JP) 2004-017016

(51) Int. Cl. H04L 9/32

(52) U.S. Cl. 713/202

(57) ABSTRACT

A sharing system is provided in which, when a detecting unit in a server apparatus receives image information from a first terminal apparatus, the server apparatus transmits image information of other terminal apparatuses to a second terminal apparatus from which input of an authentication number indicating a user who is identical to a user who is logged in with the first terminal apparatus is detected.

### BACKGROUND OF THE INVENTION

1. Field of the Invention

The present invention relates to an image distribution control technology that allows images for work statuses of respective users to be shared among the users.

2. Description of the Related Art

Group-information sharing systems that allow image information to be shared, while always connected, among a plurality of users in a group using communications networks, such as Internet networks or intranet networks, are being developed and are expected to come into widespread use. Various factors are involved behind the scenes, and examples include the spread of Internet networks, intranet networks, and so on; the spread of flat-rate billing systems based on always-on Internet connections; the advancement of digital-image compression/decompression coding technology; cost reduction resulting from use of software for processing digital-image compression/decompression coding due to an improvement in computing abilities of personal computers and so on; the spread of low-cost video capture devices (i.e., video cameras) for personal computers; and the spread of USB (universal serial bus) interfaces capable of readily providing connections between video capture devices and personal computers.

As an example of such systems, a system is available in which work status images are shared among a plurality of users over a communications network, such as the Internet, an intranet, or the like, while essentially constantly connected. For convenience of description, the term “work status image” used herein refers to an image or images regarding a user himself/herself and the situation in his/her vicinity. In practice, the work status image may be only a user's own image. In such a system, each user transmits his/her work status image from his/her terminal apparatus to a server apparatus, which, in turn, transmits and distributes the received work status images to other users' terminal apparatuses, so that a plurality of users can share the work status images. The group-information sharing system may also be used for various types of groups, including non-business communities.

In such a known group-information sharing system, work status images are essentially always (i.e., for 24 hours or during all work hours) shared among a plurality of users. In the system, however, in the first place, users' own images captured by video cameras are transmitted to other users, typically causing the users to have psychological resistance to possible invasion of their privacies. This makes the users hesitant to start the use of the system. In order to address the problems, a system that permits only a user who transmits his/her work status image to receive, display, and view work status images of other users is available.

That is, in the system, users' information is controlled on a reciprocal basis, i.e., on a basis that one user's status is transmitted to other users and the other users' statuses are also transmitted to that user. Such a controlling scheme will hereinafter be referred to as “reciprocity control”. The reciprocity control allows the users to understand and feel that they are mutually in an equal situation even if their privacies are to be invaded. In other words, the reciprocity control allows the users to feel that they are in the same situation as in a typical large unpartitioned office space in which they can mutually view the statuses of the others. This scheme, therefore, can overcome the above-described problems, including psychological resistance and hesitation in starting the use of such a group-information sharing system, which makes it possible to put the system into service with an increased sense of security while providing the advantages described above.

In recent years, however, sophistication of mobile information-terminal apparatuses (including mobile phones, compact mobile computers, and so on) and shifts in corporate climates toward accepting mobile work (i.e., business communication while away from office) have created a need for a group-information sharing system that can also be used by the users of mobile information-terminal apparatuses while away from office.

In such a case, mobile information-terminal apparatuses have built-in telephone functions, web browser functions, and so on which are non-programmable. Thus, in many cases, the reciprocity control, which is image distribution control needed for the group-information sharing system, cannot be achieved. Further, many mobile information-terminal apparatuses not only are non-programmable but also do not have video capture devices for capturing work status images.

As described above, incorporation of the reciprocity control is very important for a group-information sharing system having the work-status-image sharing function. A control scheme in which work status images of users are also transmitted to, for example, a user having a mobile information-terminal apparatus equipped with a web browser function but without an image capture function can be incorporated into a group-information sharing system. However, indiscriminately incorporating such a control scheme can cause a collapse in reciprocity of all the users and, further, an increase in a sense of invasion in privacy, and can incur users' resistance triggered thereby.

Thus, in the group-information sharing system having the work-status-image sharing function, it is preferable to permit the connections of users having mobile information-terminal apparatuses in order to deal with mobile work that has become increasingly popular in recent years. However, since those mobile information-terminal apparatuses are off-the-shelf products that are non-programmable, there is a problem in that the reciprocity control cannot be incorporated into the terminal apparatuses.

As a result, when a terminal apparatus that cannot perform reciprocity control is connected to the system, the reciprocity collapses, which makes it difficult to gain the understanding of users about the transmission of their work statuses. This hampers the promotion of the use of the group-information sharing system. Consequently, paradoxical problems arise in that the above-described advantages that can be offered by using the system cannot be obtained. Thus, how to overcome the problems has been a challenge.

### SUMMARY OF THE INVENTION

In view of the foregoing problems, an object of the present invention is to provide a system in which a reciprocity policy is not impaired even when a new type of terminal apparatus, such as a mobile information terminal, is connected to the system.

To achieve the above-described object, one aspect of the present invention provides a sharing system. When a detecting unit in a server apparatus receives image information from a first terminal apparatus, the server apparatus transmits image information of other terminal apparatuses to a second terminal apparatus from which input of an authentication number indicating a user who is identical to a user who is logged in with the first terminal apparatus is detected.

Further objects, features and advantages of the present invention will become apparent from the following description of the preferred embodiments with reference to the attached drawings.

### BRIEF DESCRIPTION OF THE DRAWINGS

FIG. 1 is a schematic view of a system of the present invention.

FIG. 2 is a view showing one example of a screen displayed on a terminal apparatus of the present invention.

FIG. 3 is a block diagram showing a terminal apparatus of the present invention.

FIG. 4 is a block diagram showing a server apparatus of the present invention.

FIG. 5 is a view showing one example of a login screen for the terminal apparatus 101 of the present invention.

FIG. 6 is a flow chart showing operational processing of each terminal apparatus according to a first embodiment of the present invention.

FIG. 7 is a flow chart showing operational processing of the server apparatus according to the first embodiment.

FIG. 8 is a view showing one example of a screen displayed on the mobile terminal apparatus 102 of the present invention.

FIG. 9 is a view showing one example of a database in the server apparatus of the present invention.

FIG. 10 is a view showing one example of a screen displayed at the terminal apparatus 101 of the present invention.

FIG. 11 is a view showing one example of the screen displayed at the terminal apparatus 101 of the present invention.

FIG. 12 is a view showing one example of a screen displayed on the mobile terminal apparatus 102 of present invention.

FIG. 13 is a view showing one example of the screen displayed on the mobile terminal apparatus 102 of the present invention.

FIG. 14 is a flow chart showing operational processing of each terminal apparatus according to a second embodiment of the present invention.

FIG. 15 is a flow chart showing operational processing of the server apparatus according to the second embodiment.

FIG. 16 is a view showing one example of a login screen for each terminal apparatus 102 of the present invention.

FIG. 17 is a view showing one example of a screen displayed at the terminal apparatus 101 according to the second embodiment.

FIG. 18 is a view showing one example of the screen displayed at the terminal apparatus 101 according to the second embodiment.

FIG. 19 is a flow chart showing operational processing of the server apparatus according to a third embodiment of the present invention.

FIG. 20 is a view showing one example of a pop-up window for notifying that one mobile terminal apparatus 102 is accessing.

### DESCRIPTION OF THE PREFERRED EMBODIMENTS

Embodiments of the present invention will be described below with reference to the accompanying drawings.

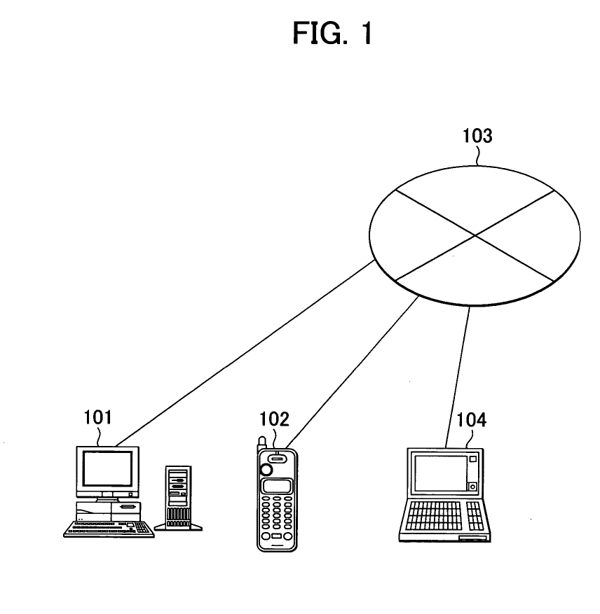

FIG. 1 is a schematic view showing the overall configuration of a group-information sharing system according to embodiments of the present invention.

Referring to FIG. 1, terminal apparatuses 101 and 102 have communication functions therein and are connected to an Internet 103. The terminal apparatus 101 is implemented by a personal computer (PC) and is operated based on a program for group-information sharing system terminal apparatuses. The terminal apparatus 102 is implemented by a mobile phone, a personal digital assistant (PDA), or the like having a wireless transmission function for mobile communication. In practice, pluralities of terminal apparatuses 101 and 102 are connected to the Internet 103. Similarly, a server apparatus 104 has a communication function therein and is connected to the Internet 103. The server apparatus 104 is implemented by a server computer and is operated based on a program for a group-information sharing system server apparatus.

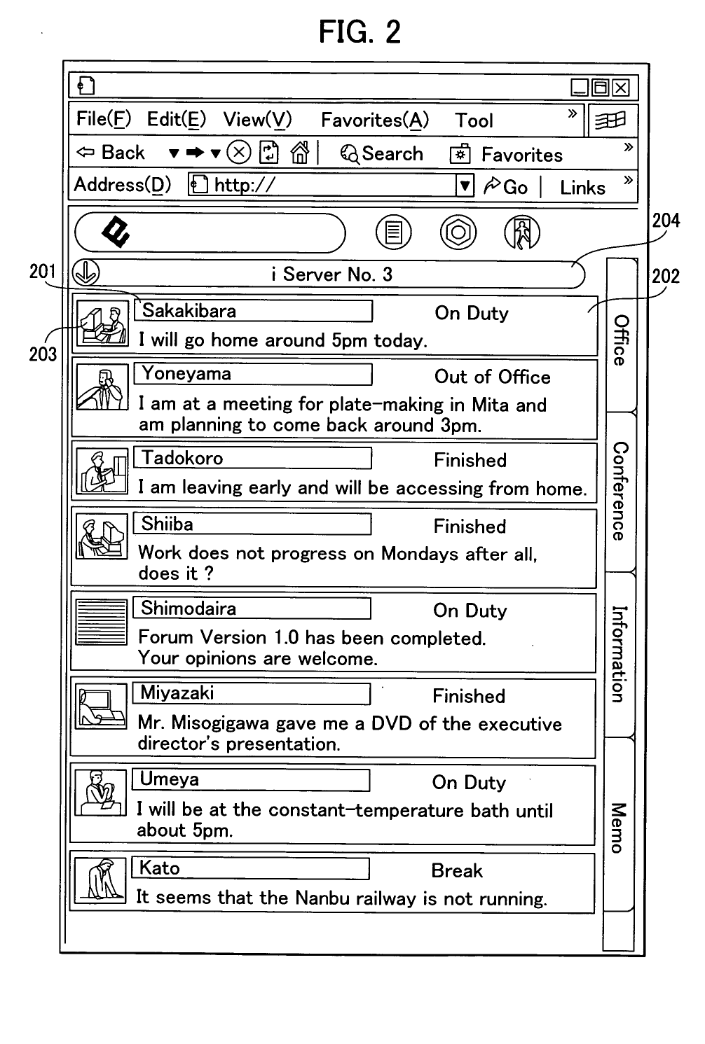

FIG. 2 shows one example of a screen displayed at each terminal apparatus 101 in this group-information sharing system. The display screen shown in FIG. 2 has a display portion 201 for displaying the name of a user using this terminal apparatus 101 and a display portion 202 for displaying message information. The message information is character information that has been distributed from the user's terminal apparatus 101 to other users via the server apparatus 104. At a display portion 203, an image that has been transmitted from the user's terminal apparatus 101 and that has been distributed to the other users via the server 104 is displayed. A display portion 204 is used to display the name of a group to which the users belong. Image information is continuously distributed via the server apparatus 104 and images are displayed in real time so that each user can view the latest statuses.

FIG. 2 shows a situation in which eight users are registered as one group in the server apparatus 104 to make use of the service. In principle, the display screen shown in FIG. 2 is displayed on the screen of the terminal apparatus 101 of each user who belongs to the group.

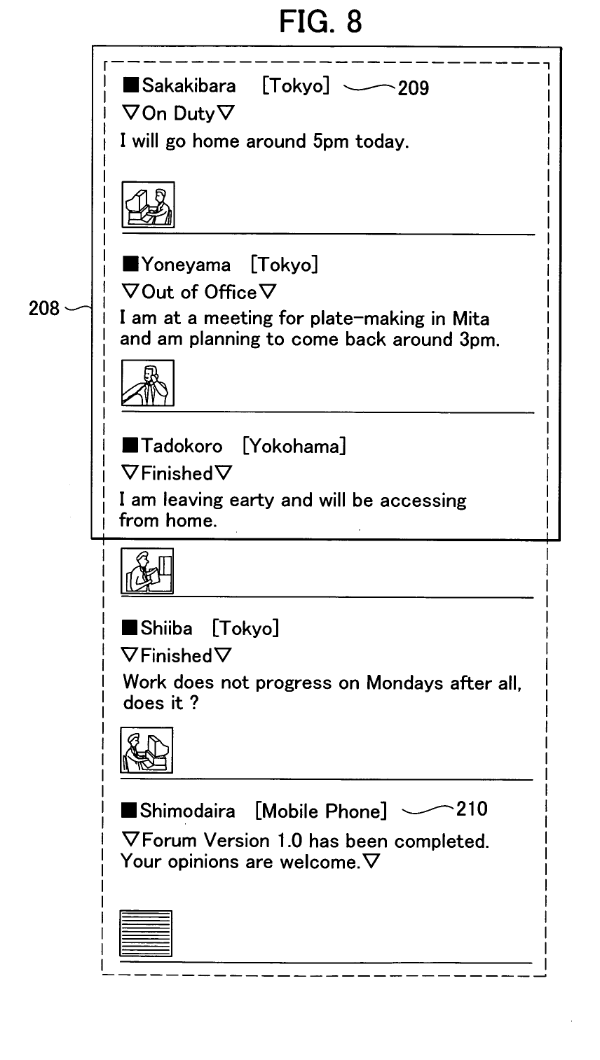

FIG. 8 shows one example of an information layout displayed on each terminal apparatus 102, such as a mobile phone. A region 208 represents a region that can be actually displayed on the terminal apparatus 102. Scrolling the screen with a scroll button or the like causes information at the lower side in FIG. 8 to be displayed. This arrangement is provided since the area displayed at a time is small due to the limitation (i.e., size) of the display section of a mobile telephone or the like. In the case of FIG. 8, for example, information 209 regarding the location of the terminal apparatus and information 210 indicating the type of apparatus, such as a mobile phone, can also be displayed, as in the case of FIG. 2.

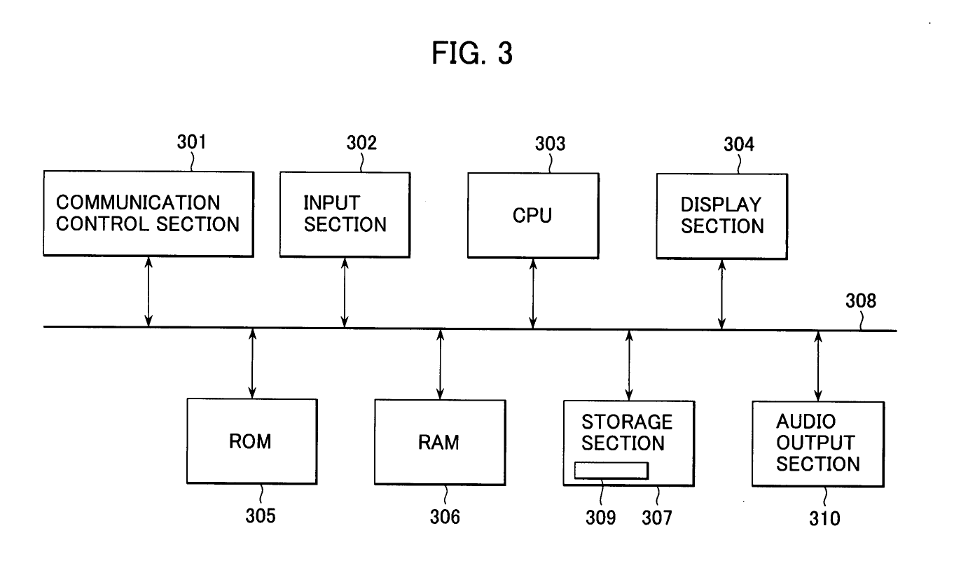

FIG. 3 is a block diagram showing the configuration of the user terminal apparatuses 101 and 102 in the present invention. As described above, the terminal apparatuses 101 and 102 are implemented by PCs and mobile phones, respectively, and operate as group-information sharing system terminal apparatuses. First, a description is given of the configuration of the terminal apparatuses 101. Specifically, each of the terminal apparatuses 101 includes a communication control section 301, an input section 302, a CPU (central processing unit) 303, a display section 304, a ROM (read only memory) 305, a RAM (random access memory) 306, and a storage section 307.

The communication control section 301 processes communication control for connection to the Internet 103, and various types of communication interfaces can be applied to the communication control section 301 depending on a user's environment. For direct connection to an access network, the communication control section 301 may be implemented by various types of modems or terminal adapters, and for connection to an ADSL (asymmetric digital subscriber line) modem or cable modem in an external apparatus, the communication control section 301 may be implemented by an Ethernet interface.

The input section 302 may include a keyboard, a mouse, a microphone, and a video camera. The keyboard is used to obtain message information entered by the user and the video camera is used to capture a work status video image containing a video image of the user and the surrounding situation.

The CPU 303 performs processing for controlling the entire personal computer, i.e., the terminal apparatus 101, and also performs processing requested by program data 309 for group-information sharing system terminal apparatuses.

The display section 304 may be implemented by a CRT (cathode ray tube) display or a liquid crystal display, and the exemplary display screen shown in FIG. 2 is displayed on the screen of the display section 304.

The ROM 305 stores commands and data required for the CPU 303.

The RAM 306 is used as a work memory needed for the operation of the CPU 303.

The storage section 307 is typically a hard disk drive. The storage section 307 stores the program data 309 for group-information sharing system terminal apparatuses and also stores data needed for the operation of the program data 309.

The audio output section 310 may include a sound-source circuit, an audio amplifier circuit, and a sound outputting speaker. The individual blocks 301 to 307 and 310 are connected to a system bus 308.

The configuration of the terminal apparatuses 102 will now be described. The terminal apparatuses 102 are mobile information-terminal apparatuses, including mobile phones and compact mobile computers. While the performances may differ, the internal configuration of the terminal apparatuses 102 is similar to the configuration of the terminal apparatuses 101 and thus the description thereof is omitted. Each mobile information-terminal apparatus 102 has therein a wireless transmission function for mobile communication, an HTML browser function., and an Internet connection function. The terminal apparatus 102 further has input keys as the input section 302. The input keys are used as numeric keys for inputting a subscriber's telephone number when the telephone function is used. Further, when a web page described in an HTML format is viewed, the input keys are used for inputting alphabetic characters, for example, in order to specify a particular web page the user wishes to view or in order to enter a user ID, prompted to enter, in the web page. A liquid crystal display unit may be used for the display section 304 to display a web page. As one example of mobile phones, a model that can simultaneously display a web page with up to 110 characters on the liquid-crystal display screen and also can display a JPEG-format image file on a web page is available.

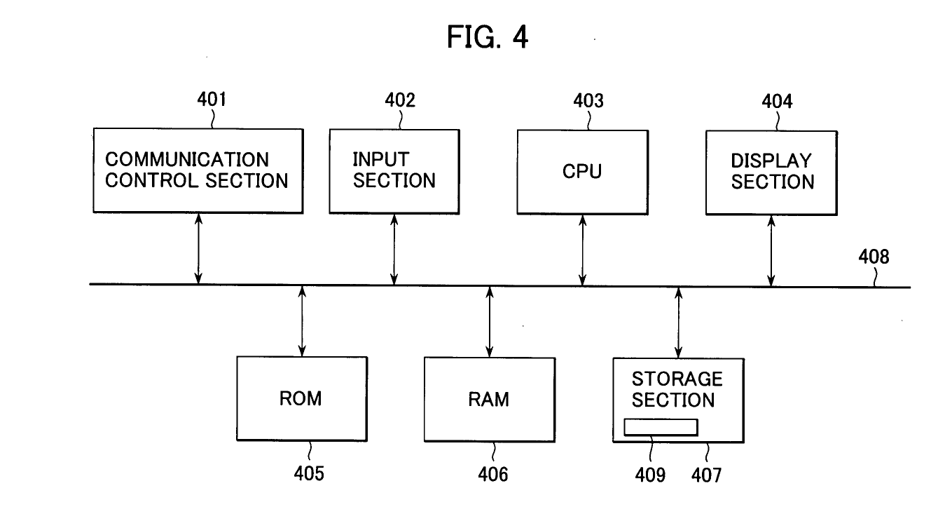

FIG. 4 is a block diagram showing the configuration of the sever apparatus 104 in the present invention. As described above, the server apparatus 104 is implemented by a server computer and is operated based on program data 409 for a group-information sharing system server apparatus. Specifically, the server apparatus 104 includes a communication control section 401, an input section 402, a CPU 403, a display section 404, a ROM (read only memory) 405, a RAM (random access memory) 406, and a storage section 407.

The communication control section 401 processes communication control for connection to the Internet 103. The server apparatus 104 is typically installed at a NOC (network operation center) of an Internet service provider that is close to an Internet backbone network, and thus is implemented by a high-speed Ethernet communication interface for connection to the router of the NOC.

The input section 402 may include a keyboard and a mouse for management of the server computer 104. Alternatively, without the keyboard and the mouse, information regarding management processing may be input from a management computer that is connected through a network.

The CPU 403 performs processing for controlling the entire server computer 104 and also performs processing requested by the program data 409 for a group-information sharing system server apparatus.

The display section 404 may be implemented by a CRT display or a liquid crystal display.

The ROM 405 stores commands and data required for the CPU 403.

The RAM 406 is used as a work memory needed for the operation of the CPU 403.

The storage section 407 is typically a hard disk drive. The storage section 407 stores the program data 409, data needed for the operation of the program data 409, data base information regarding the users, and message information data transmitted from the terminal apparatuses 101 and 102. The individual blocks 401 to 407 are connected to a system bus 408.

At each terminal apparatus 101, the video camera included in the input section 302 captures an image of the surrounding area. Through the processing performed by the CPU 303, the communication unit 301 transmits the captured image to the server apparatus 104 over the Internet 103 and so on. The video camera automatically performs the image-capture operation at regular intervals (e.g., twice a second or once every ten seconds) and transmits the captured image to the server apparatus 104. After the transmission of the image, in turn, the terminal apparatus 101 receives screen layout information from the server apparatus 104 and further receives captured images of other users from the server apparatus 104. When message information, which is a user's text information, is entered at each terminal apparatus, the message information is distributed to other terminal apparatuses via the server apparatus 104.

Next, the operational flow of an image distribution control method according to a first embodiment of the present invention in the group-information sharing system having the above-described configuration will be described in detail with reference to flow charts. The flow charts described below show the flow of control that is performed by the CPU 303 and the CPU 403 in accordance with the corresponding program data 309 and 409 stored in the corresponding storage sections 307 and 407 and the like of each PC terminal apparatus 101 and the server apparatus 104.

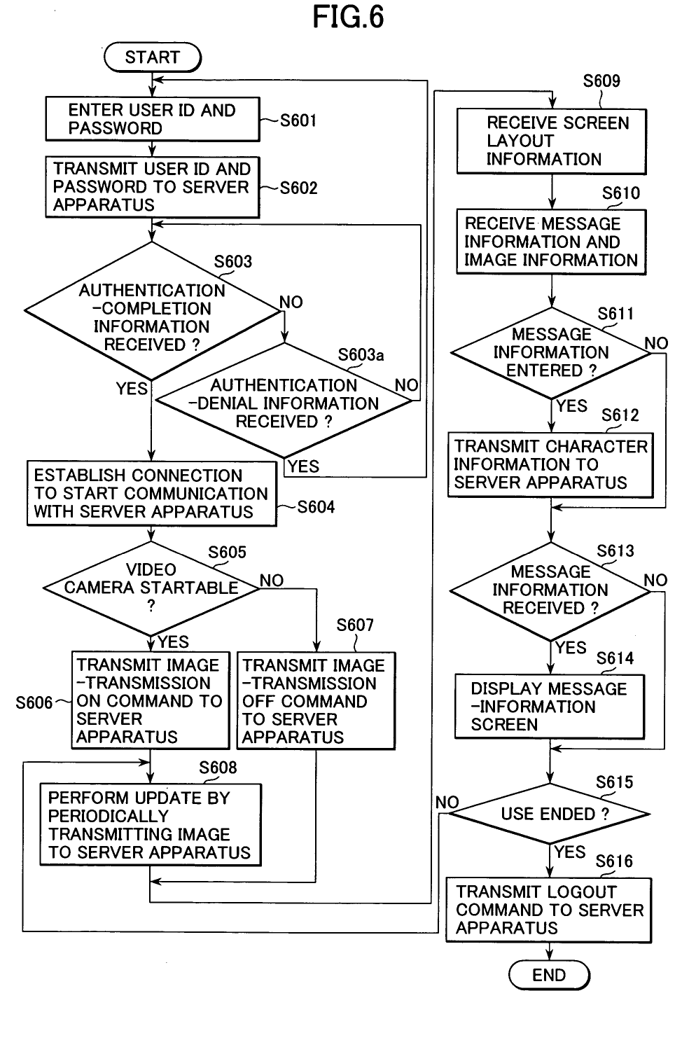

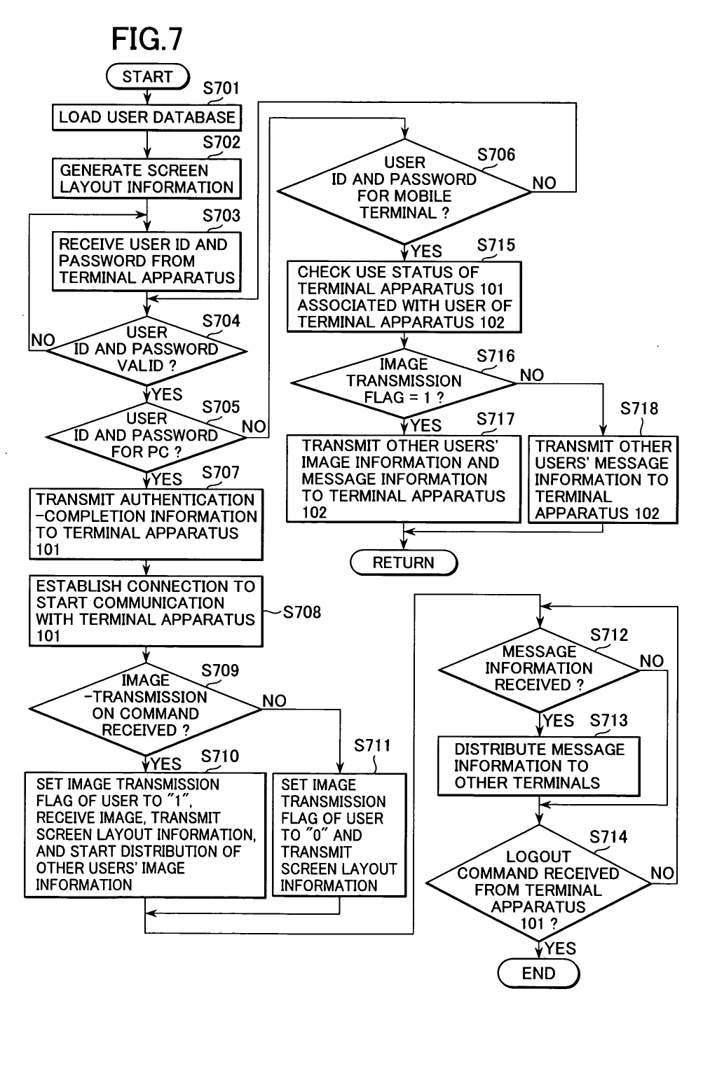

FIG. 6 is a flow chart of the operation of each terminal apparatus 101 and FIG. 7 is a flow chart of the operation of the server apparatus 104. For simplicity of description, it is presumed that the terminal apparatuses 101 and the server apparatus 104 are already connected to the Internet 103 via the corresponding communication control sections 301 and 401.

Referring to FIG. 7, after the server apparatus 104 is started, in step S701, user information that is stored in a database is loaded into the RAM 406 from the storage section 407, in accordance with the operation of the program for a group-information sharing system server apparatus. In this case, the stored user information has been input by the administrator of the server apparatus 104 using the keyboard and so on of the input section 402. In step S702, in accordance with the content of the database, the server apparatus 104 generates screen layout information needed for displaying a user interface screen, as shown in FIG. 2, for the terminal apparatus 101, and stores the screen layout information in the RAM 406.

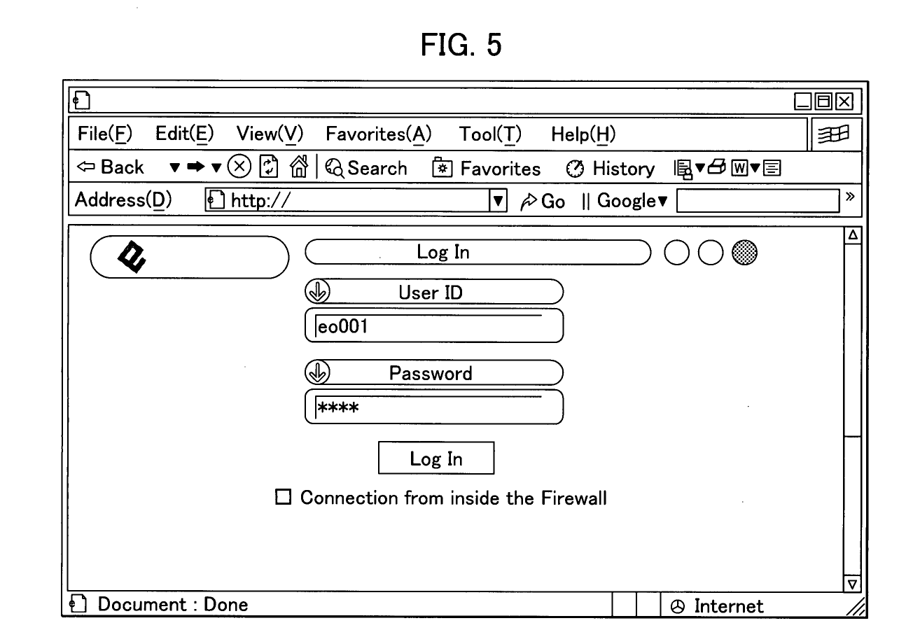

Referring to FIG. 6, on the other hand, the terminal apparatus 101 is started, and then causes the display section 304 to display a screen (shown in FIG. 5) for prompting the user to enter his/her user ID and password, in accordance with the operation of the program for group-information sharing system terminal apparatuses. Upon detecting the entry of the user ID and password in step S601, the terminal apparatus 101 transmits a connection request containing those values to the server apparatus 104 through the communication control section 301 and the Internet 103 in step S602.

Referring to FIG. 7, in step S703, the server apparatus 104 receives the user ID and password. In step S704, the server apparatus 104 determines whether or not the user ID (i.e., an authentication number) and password are valid. Specifically, the server apparatus 104 authenticates the user ID and password by checking them against user registration information registered in the database. When it is determined YES, i.e., is determined to be valid, a determination is further made in step S705 as to whether or not the user ID and password which have been received in step S703 are registered, as a user ID and password for a PC (personal computer), in the user registration information. When it is determined NO in step S705, a determination is made in step S706 as to whether or not they are registered, as a user ID and password for a mobile terminal, in the user registration information.

On the other hand, when it is determined in step S705 that the received user ID and password are registered in the user registration information as a user ID and password for PC connection, in step S707, the server apparatus 104 transmits authentication-completion information to the terminal apparatus 101, which is a PC. In step S708, the server apparatus 104 starts communication with the terminal apparatus 101 over the Internet 103.

Referring to FIG. 6, in step S603, a determination is made as to whether or not the terminal apparatus 101 receives the authentication-completion information transmitted in step S707. When it is determined YES, in step S604, the terminal apparatus 101 establishes a connection for communication with the server apparatus 104 to start communication, and then immediately attempts to start the video camera included in the input section 302. When the terminal apparatus 101 receives authentication-denial information instead of the authentication-completion information in step S603a, the process returns to step S601. On the other hand, after step S604, a determination is made as to whether or not the video camera, which serves as the input section 302 of the terminal apparatus 101, is properly connected to the terminal apparatus 101 and as to whether or not the data of the surrounding area's image (i.e., a work status image) captured by the video camera can be obtained via the system bus 308. When it is determined YES in step S605, that is, when it is determined that the video camera at the terminal apparatus 101 can be started by the operation of the program data 309 for group-information sharing system terminal apparatuses, the terminal apparatus 101 transmits an “image-transmission ON command” to the server apparatus 104 in step S606.

When the video camera at the terminal apparatus 101 cannot be started for some reason (e.g., the video camera is not properly connected or the user intentionally turns off the power of the video camera) in the process described above, the terminal apparatus 101 transmits an “image-transmission OFF command” to the server apparatus 104 in step S607.

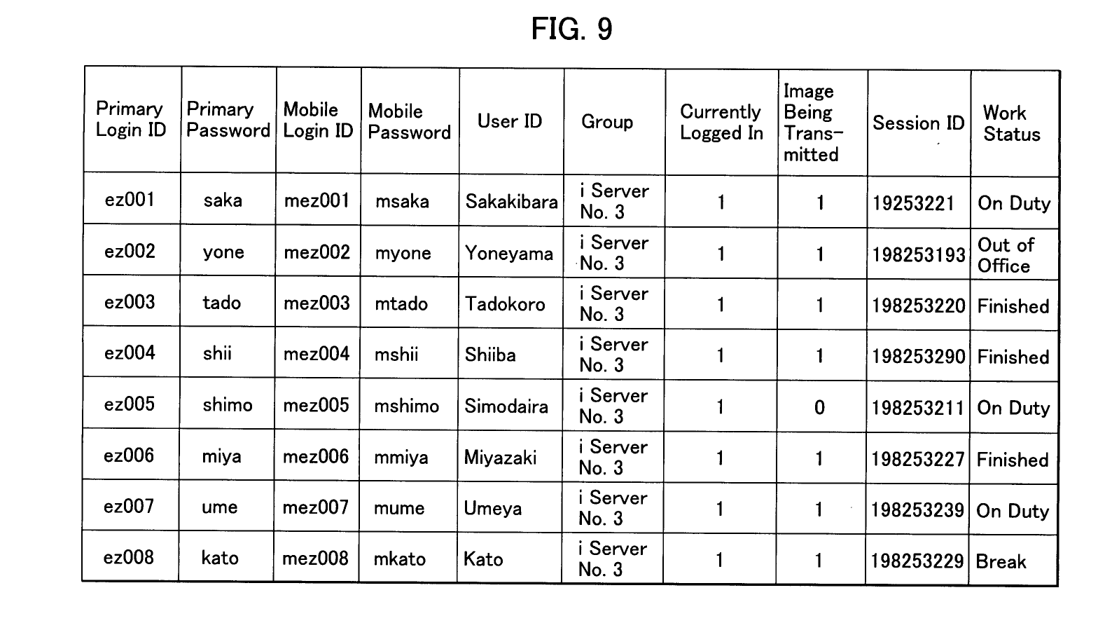

Referring to FIG. 7, upon receiving the image-transmission ON command in step S709, the server apparatus 104 sets an “image transmission flag” to “1” in step S710. The image-transmission flag is one type of connection status information of the user that has connected from the terminal apparatus 101. Subsequently, in step S710, the server apparatus 104 receives image information from the terminal apparatus 101 and transmits to the terminal apparatus 101 layout information that contains image information received from other terminal apparatuses. On the other hand, when it is determined NO in step S709, i.e., when the image-transmission OFF command is received, in step S711, the server apparatus 104 sets the “image transmission flag” to “0” and transmits to the terminal apparatus 101 layout information that does not contain image information received from other terminal apparatuses. Once either of the flags is set, its value is immediately recorded in the database of the server apparatus 104. FIG. 9 shows an example in which those values are recorded in the database.

When the terminal apparatus 101 transmits the image-transmission ON command to the server apparatus 104 in step S606, the terminal apparatus 101 immediately starts the image-capture operation of the video camera and transmits a captured image to the server apparatus 104. Further, in step S608, the terminal apparatus 101 automatically repeats updating of the image, that is, repeatedly captures an image and transmits the image to the server apparatus 104 at regular intervals (e.g., twice a second or once every ten seconds). In step S609, the terminal apparatus 101 receives the screen layout information from the server apparatus 104. In step S610, the terminal apparatus 101 receives message information and image information of users who are connecting from other terminal apparatuses and displays the information in a format as shown in FIG. 2.

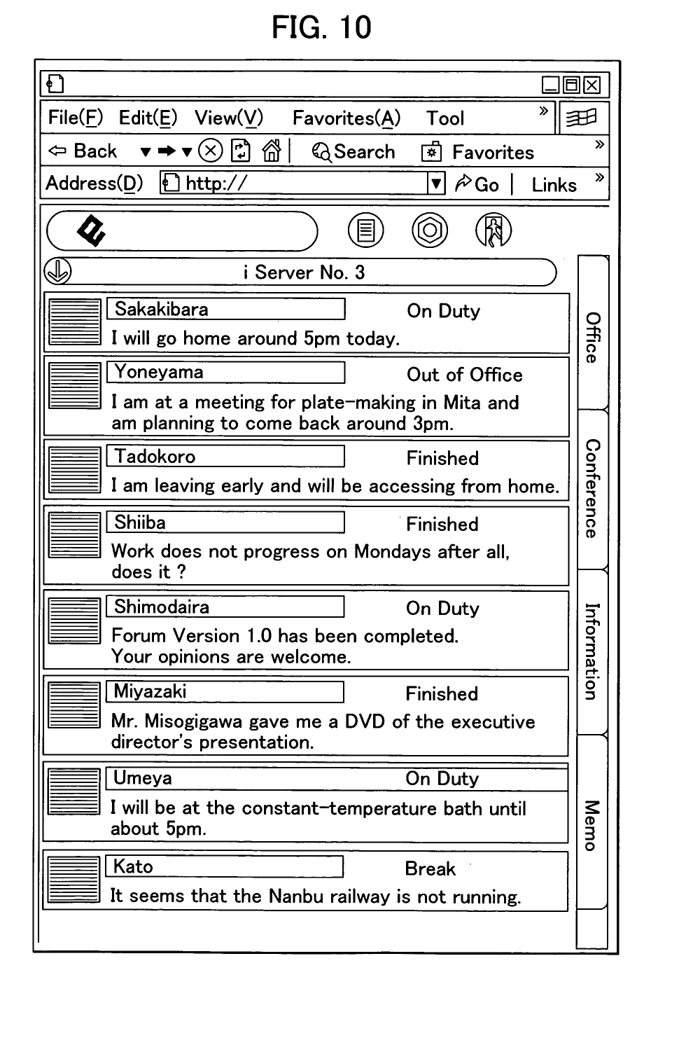

As described above, when the terminal apparatus 101 transmits the image-transmission OFF command to the server apparatus 104 in step S607, work status images uploaded from other terminal apparatuses to the server apparatus 104 are not distributed to that terminal apparatus 101, but only screen layout information and message information are transmitted for display, based on the concept of the above-described reciprocity control. An exemplary screen that is displayed on the display section 304 of the terminal apparatus 101 in such a case is illustrated in FIG. 10.

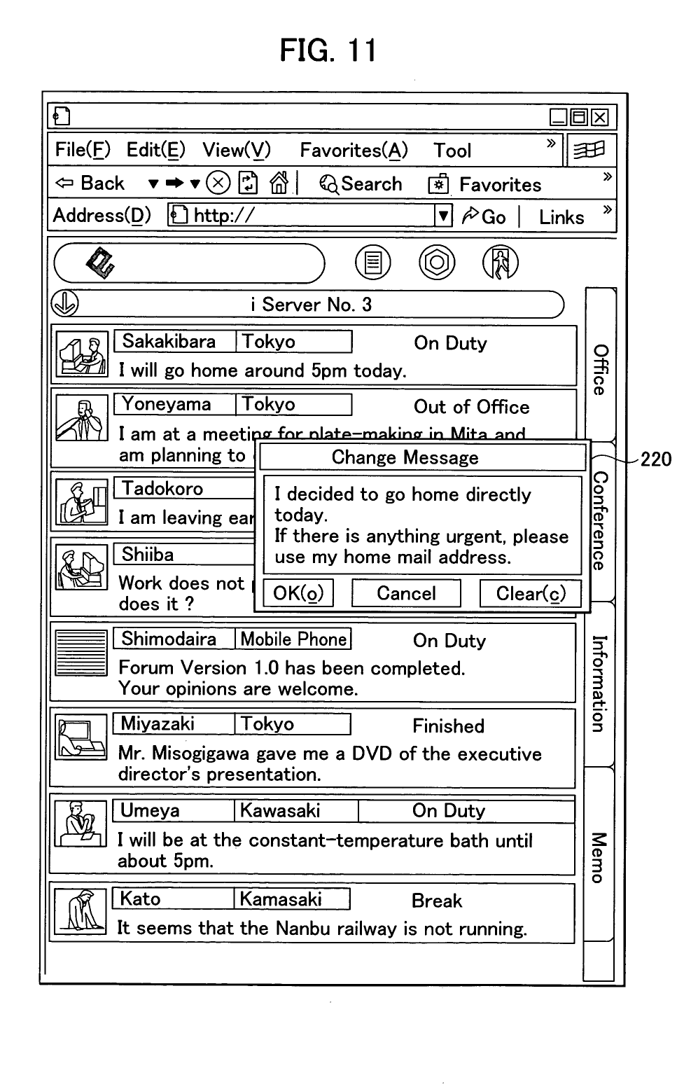

At the terminal apparatus 101, when message information is entered in step S611 (a screen for inputting character information is shown in FIG. 11) regardless of whether an image is to be transmitted, the entered character information is transmitted to the server apparatus 104 in step S612 and is, in turn, transferred to other users' terminal apparatuses. In this case, the message information always includes the user ID of a user that transmits the message. Upon receiving such message information from any of currently-connecting terminal apparatuses 101 in step S712, the server apparatus 104 immediately transfers and distributes its content (i.e., the message information containing the user ID of the sender) to all the terminal apparatuses in step S713.

Upon receiving the message information from the server apparatus 104 in step S613, in step S614, each terminal apparatus 101 displays the message information at a display position specified by the screen layout information that has been received from the server apparatus 104, by referring to the user ID of the sender of the message information. When the user wishes to end the connection with the system in step S615, the terminal apparatus 101 transmits a logout command to the server apparatus 104 in step S616.

In turn, upon receiving the logout command from the terminal apparatus 101 in step S714, the server apparatus 104 ends the connection with the terminal apparatus 101.

As described above, as in the exemplary screen shown in FIG. 2, all users registered in the user registration information for the same group can check messages on the respective screens having similar layouts at the display sections of the terminal apparatuses 101. When one user wishes to change his/her message, a changed message is immediately reflected on the screens of all the users in a similar display format via the server apparatus 104 according the above-described method. When the terminal apparatus transmits a work status image using a video camera, his/her and other users' work status images are updated and displayed on the corresponding display section. On the other hand, when the terminal apparatus does not transmit a work status image, a screen that does not contain other users' work status images, as shown in FIG. 10, is displayed on its display section.

Now, a description is given of an image distribution control method for a case in which the terminal apparatus 102, such as a mobile phone, connects to the server apparatus 104. In this embodiment, it is presumed that the terminal apparatus 102 has no camera function.

In general, when in use, the terminal apparatus 102 is always powered on so as to be in a state in which making or receiving a call is possible and the Internet connection function can be started, except for a case in which the use of mobile terminals is prohibited when on board a public transportation system.

In the group-information sharing system according to this embodiment, one user utilizes the terminal apparatus 101, which is typically a PC, to transmit a work schedule video to other users' terminal apparatuses 101. In this embodiment, when a user goes out of office while leaving the terminal apparatus 101 in an operating state (i.e., the communication connection is maintained to allow the transmission of a work status image), the user on the road can know, when wishing to know the statuses of other users in the group, the statuses through displayed work status images, by connecting to the server apparatus 104 with his/her mobile terminal apparatus 102.

The operation of the system when access is made from such a mobile terminal 102 will now be described with reference to the flow chart shown in FIG. 7. First, the user performs operation using the Internet connection function and the web browser function of the terminal apparatus 102 to establish a connection with the server apparatus 104 over the Internet 103. The user then enters his/her user ID and password and transmits a connection request containing the values to the server apparatus 104.

In return, the server apparatus 104 receives the user ID and password in step S703, and then determines whether or not the user ID and password are valid in step S704. Specifically, the server apparatus 104 performs the determination by checking the user ID and password against user registration information registered in the database. When it is determined YES in step S704, i.e., is determined to be valid, a determination is further made in step S705 as to whether or not the user ID and password which have been received in step S703 are registered, as a user ID and password for PC connection, in the user registration information. When it is determined NO in step S705, a determination is made in step S706 as to whether or not they are registered, as a user ID and password for a mobile terminal apparatus, in the user registration information. In this case, since the user is connecting to the server apparatus 104 from his/her mobile terminal apparatus 102, it is determined in step S706 that the received user ID and password are valid for a mobile terminal. In step S715, the server apparatus 104 immediately checks the use status, i.e., the connection status with the server apparatus 104, of a PC terminal apparatus 101 associated with the user who is connecting to the server apparatus 104 with those user ID and password. In step S716, the server apparatus 104 refers to the database therein to check the value of an image transmission flag.

Specifically, a determination is made in step S716 as to whether or not the PC terminal apparatus 101 that is associated with the user who is connecting from his/her mobile terminal apparatus 102 to the server apparatus 104 has transmitted his/her work status image to the server apparatus 104. When it is determined YES (i.e., the transmission flag=1), in step S717, the server apparatus 104 generates a web screen containing message information and image information (work status images) transmitted from all the user terminal apparatuses in the group to which that user belongs and transmits the web screen to the mobile terminal apparatus 102. As a result, a screen as shown in FIG. 8, i.e., a screen containing both message information and work status images of all the users, is displayed on the display section 304 of the terminal apparatus 102.

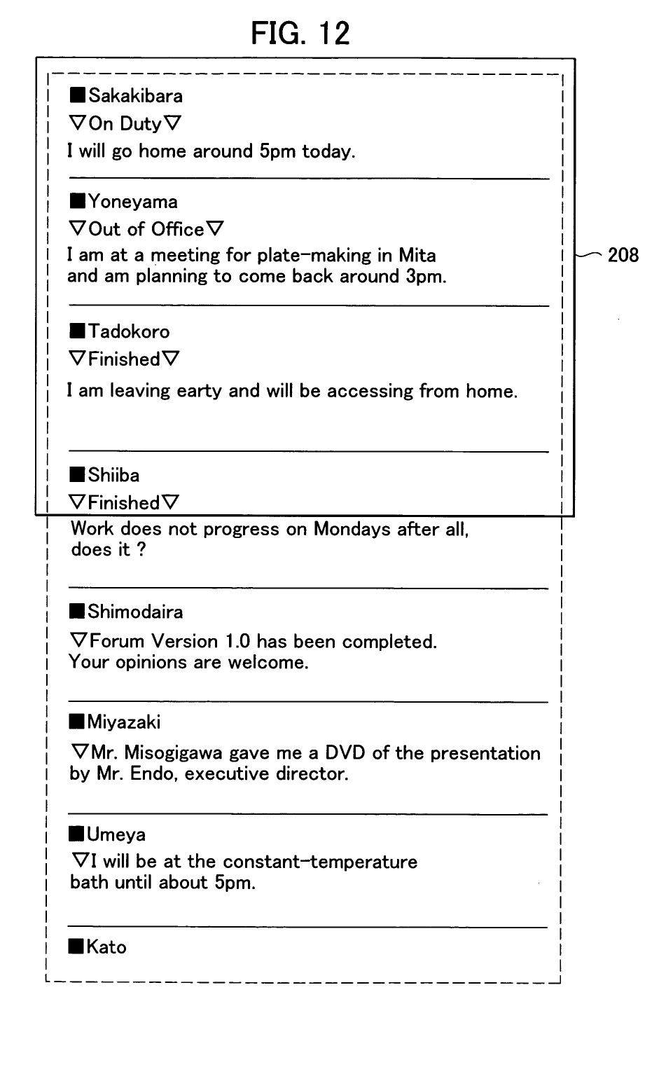

When it is determined in step S716 that the PC terminal apparatus 101 that is associated with the user who is connecting from his/her mobile terminal apparatus 102 to the server apparatus 104 has not transmitted his/her work status image to the server apparatus 104 (i.e., the image transmission flag=0), in step S718, the server apparatus 104 generates a web screen containing only message information of the users in the group to which the user belongs, and transmits the web screen to the terminal apparatus 102, without transmitting the work status images. An example of a screen displayed in such a case is illustrated in FIG. 12.

When a user needs to be away from the location of his/her PC terminal apparatus 101 because of a business trip or the like and wishes to know the statuses of other users in the same group by using his/her mobile terminal apparatus 102, the user can display other users' work status images on his/her mobile terminal apparatus 102 when his/her PC terminal apparatus 101 is transmitting his/her work status image, as described above. This arrangement, therefore, allows a user to obtain other users' presence/absence information and the like and thus allows the user to obtain useful information for selecting a communication tool and/or for deciding communication timing for business communications with the other users. On the other hand, even when a user whose PC terminal apparatus 101 has not transmitted his/her work status image gives a request for obtaining work status images of other users in the group by using his/her mobile terminal apparatus 102, the server apparatus 104 does not give permission for the request and transmits only message information of other users to the mobile terminal apparatus 102. This arrangement can prevent a group-wide sense of invasion of privacy and sense of unfairness, and also can promote the transmission of work status images using PC terminal apparatuses 102.

In this embodiment, as shown in FIG. 9, for each user, different character strings are used, by way of example, for a combination of a user ID and a password (a “primary login ID” and a “primary password” in FIG. 9) used for establishing a connection from the PC terminal apparatus 101 to the server apparatus 104 and a combination of a user ID and a password (a “mobile login ID” and a “mobile password” in FIG. 9) used for establishing a connection from the mobile terminal apparatus 102 to the server apparatus 104. Those combinations, however, do not necessarily have to be different from each other, and may be the same character strings. In such a case, different URLs and IP addresses are used for connection from the PC terminal apparatuses 101 and for connection from the mobile terminal apparatuses 102, so that the server apparatus 104 can identify which type of terminal apparatuses 101 and 102 is issuing a connection request. Alternatively, HTTP header information received from the terminal apparatus may be used to allow the server apparatus 104 to identify which type of terminal apparatuses 101 and 102 is issuing a connection request. Since such methods are well known to those skilled in the art, the descriptions thereof are omitted.

A second embodiment of the present invention will now be described.

According to a second embodiment of the present invention, in the group-information sharing system shown in FIG. 1, the user of a mobile terminal apparatus 102 can view work status images transmitted from other users' terminal apparatuses, without limitation. In exchange for it, however, the other users who are using their terminal apparatuses 101 other than mobile terminal apparatuses 102 are notified, by means of display and/or sound, that the user of the mobile terminal apparatus 102 is connecting to the system to view work status images of the other terminal apparatuses.

Thus, this image distribution control method can prevent the user of a mobile terminal apparatus 102 from viewing work status image of another user who is connecting from a PC terminal apparatus 101 without the latter user being noticed. This makes it possible to alleviate a sense of insecurity and a sense of caution about being monitored.

Since the configuration of the system in the second embodiment is analogous to that in the first embodiment, the description thereof is omitted.

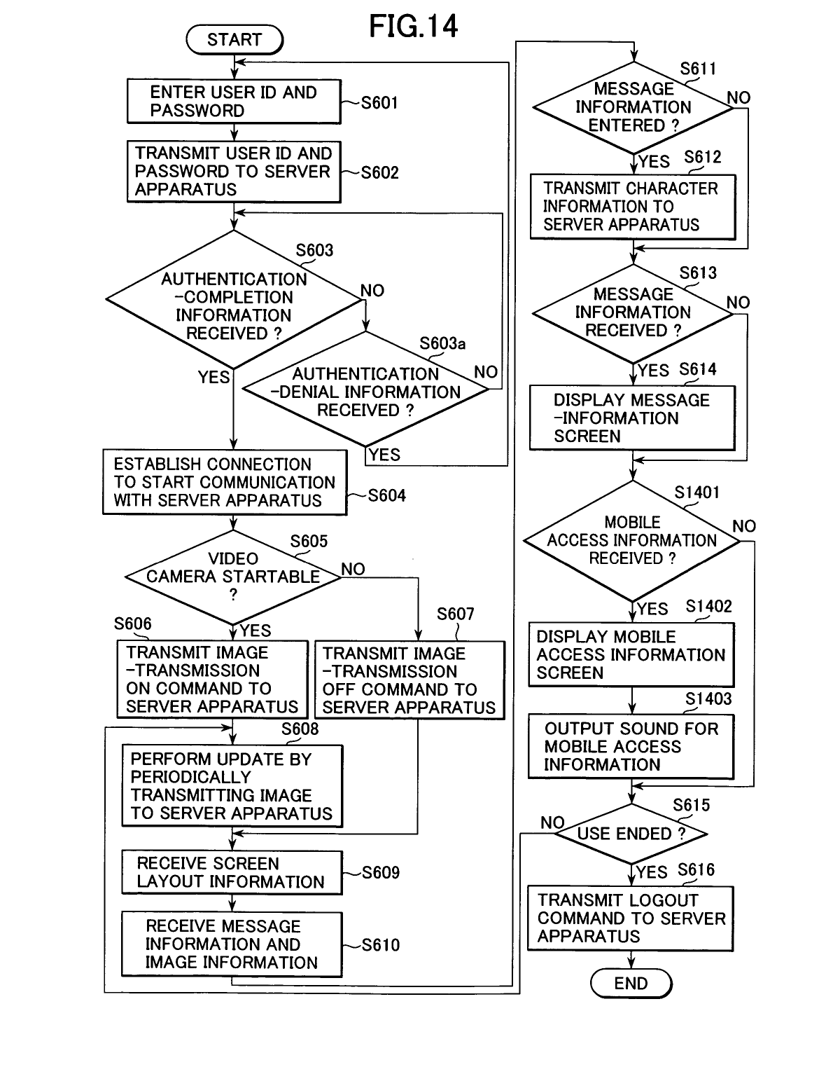

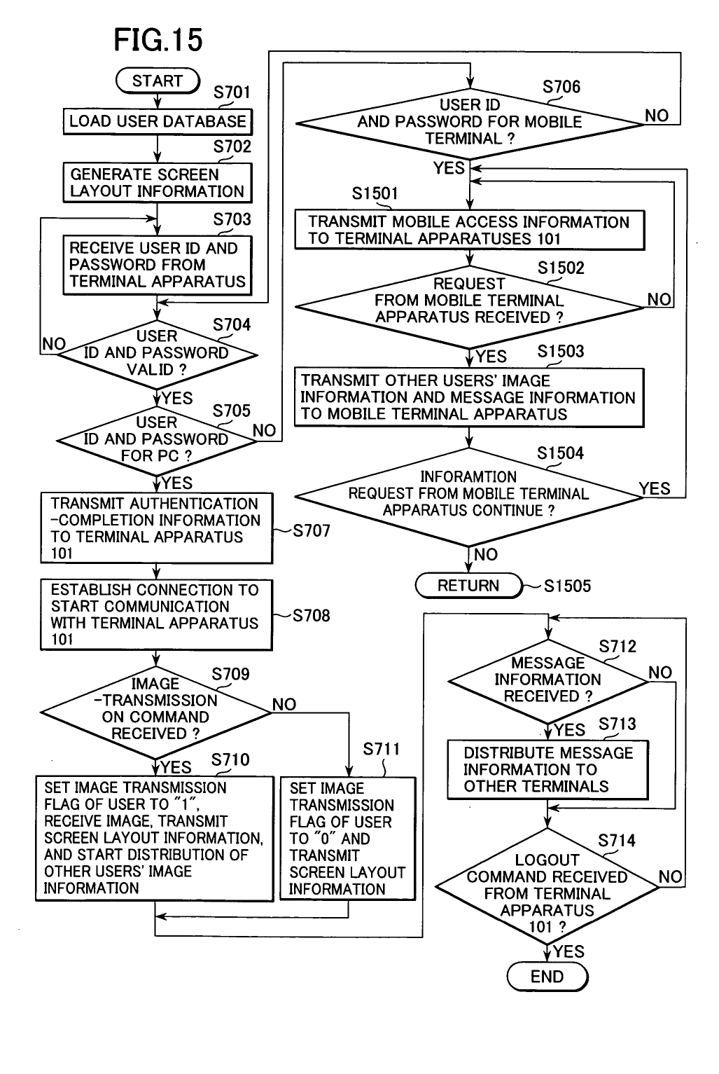

FIG. 14 is a flow chart showing the operation of each terminal apparatus 101 that can transfer image information and FIG. 15 is a flow chart showing the operation of the server apparatus 104. For simplicity of description, it is presumed that the terminal apparatuses 101 and the server apparatus 104 are already connected over the Internet 103.

The same reference numerals shown in FIG. 14 as those in FIG. 6 and the same reference numerals shown in FIG. 15 as those in FIG. 7 denote the same operations, and thus the descriptions thereof are omitted.

In response to a connection request for the system from the mobile terminal apparatus 102, the server apparatus 104 issues mobile access information indicating that the mobile terminal apparatus 102 is accessing to the system, and in step S1501 in FIG. 15, the server apparatus 104 transmits the mobile access information to other terminal apparatuses 101 in the group. In step S1401 in FIG. 14, each terminal apparatus 101 receives the mobile access information. In step S1402, each terminal apparatus 101 causes the display section 304 to display an image for notifying its user that the mobile terminal apparatus 102 is connecting to the server apparatus 104, based on the operation of the program data 309 for group-information sharing system terminal apparatuses. When provided with the audio output section 310, in step S1403, each terminal apparatus 101 issues an alert sound for notifying the user that the terminal apparatus 102 is connecting to the server apparatus 104.

In this case, the server apparatus 104 may transmit only the mobile access information to the other terminal apparatuses or may transmit information containing the identity of the user of the connecting mobile terminal apparatus 102. In the latter case, the server apparatus 104 may transmit the mobile access information containing the user ID (which is the same mobile access ID shown in FIG. 9, as described above) that has been transmitted from the terminal apparatus 102 and that has been determined to be valid in step S706.

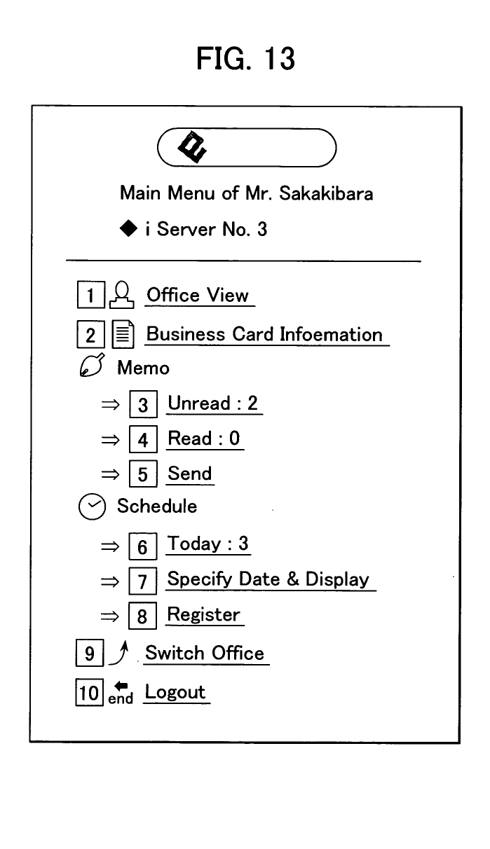

At this point, on the display section 304 of the mobile terminal apparatus 102, an exemplary main menu shown in FIG. 13 is displayed. Thus, at this point, the terminal apparatus 102 is not yet in a mode capable of receiving and viewing work status images and messages of the users of other terminal apparatuses.

In this state, an instruction for displaying “Office View” shown in FIG. 13 is given. Specifically, the user puts the portion indicating “Office View” into a highlighted state (i.e., a selectable state) using a direction button at the input section and further depresses an enter button at the input section. Since the details of such operations are of a typical method for mobile phones or the like and thus are well known, the descriptions thereof are omitted. The user then transmits “office-view request information”, which serves as a request for message information and image information (i.e., work status images). In step S1502, a determination is made as to whether the server apparatus 104 receives the “office-view request information” from the terminal apparatus 102 over the Internet 103.

Upon receiving the request information for the image information and message information, in step S1503, the server apparatus 104 transmits the requested image information and message information to the terminal apparatus 102 that has requested the information.

In turn, the terminal apparatus 102 receives the information and displays a screen as shown in FIG. 8 using the web browser function included in the terminal apparatus 102. The server apparatus 104 continuously monitors the information request (for image information and message information) from the connecting mobile terminal apparatus 102. Thus, in step S1504, a determination is made as to whether or not the information request continues for a certain period of time (e.g., for five minutes). This time setting is written in the program data 409 for a group-information sharing system server apparatus. When it is determined YES in step S1504, the server apparatus 104 continually transmits the mobile access information to other terminal apparatuses 101. That is, information indicating that the connection from the mobile terminal apparatus 102 to the server apparatus 104 is still maintained is transmitted to the terminal apparatuses 101. Also, by continually (repeatedly) giving the information request, the user of the terminal apparatus 102 can obtain the latest work-status images and message information in the display format shown in FIG. 8, without re-entering the user ID and password.

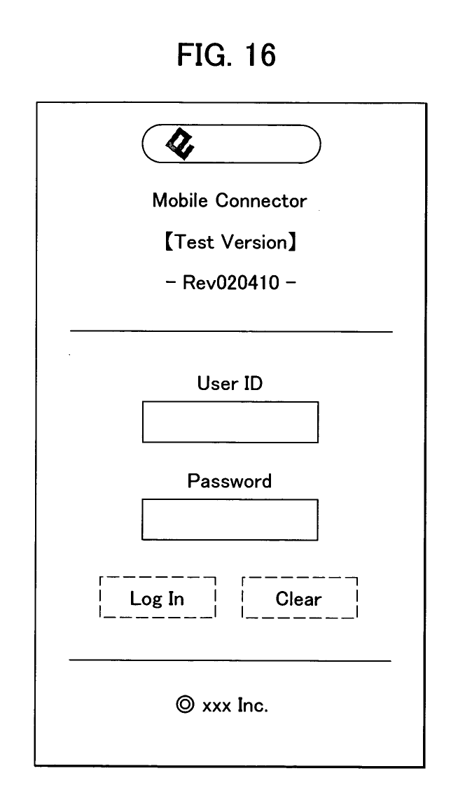

When the information request is not re-entered at the mobile terminal apparatus 102 for a certain period of time, the server apparatus 104 disconnects the communication with the mobile terminal apparatus 102 in step S1505. Thereafter, even when the user of the mobile terminal apparatus 102 enters a request for “Office View” shown in FIG. 13, the screen shown in FIG. 8 is not updated, but instead a login screen shown in FIG. 16 is displayed.

Next, control at each terminal apparatus 101, which is implemented by a PC, during the above-described process will be described with reference to the flow chart shown in FIG. 14.

When the server apparatus 104 issues the mobile access information indicating the presence of a user who is accessing from the mobile terminal apparatus 102, the PC terminal apparatus 101 receives the mobile access information in step S1401.

Subsequently, in step S1402, the terminal apparatus 101 causes the display section 304 to display an image for notifying its user that the mobile terminal apparatus 102 is connecting to the server apparatus 104, based on the operation of the program data for group-information information sharing system terminal apparatuses. When provided with the audio output section 310, in step S1403, the terminal apparatus 101 issues an alert sound for notifying the user that the mobile terminal apparatus 102 is connecting to the server apparatus 104.

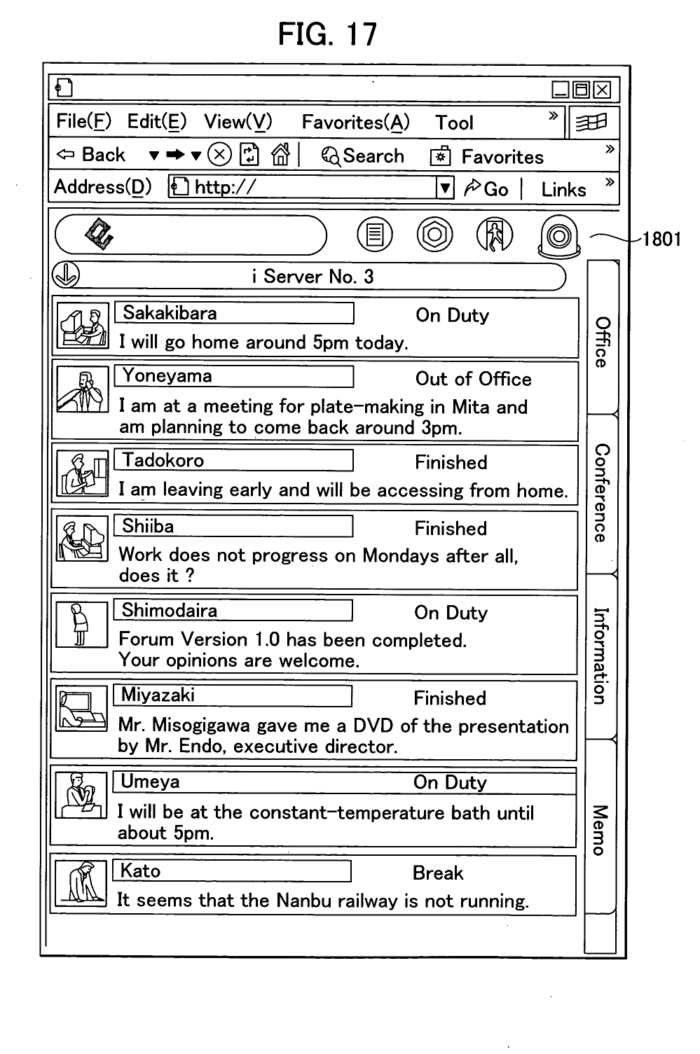

As described above, the server apparatus 104 may transmit only the mobile access information to the terminal apparatus 101 or may transmit the mobile access information containing the user ID of the user who is using the mobile terminal apparatus 102. When the former mobile access information is transmitted (i.e., when the identity of the user who is accessing to the system using the mobile terminal apparatus 102 is not transmitted to other terminal apparatuses 101), an icon like a patrol lamp (or a warning light) 1801 is displayed on a screen as shown in FIG. 17.

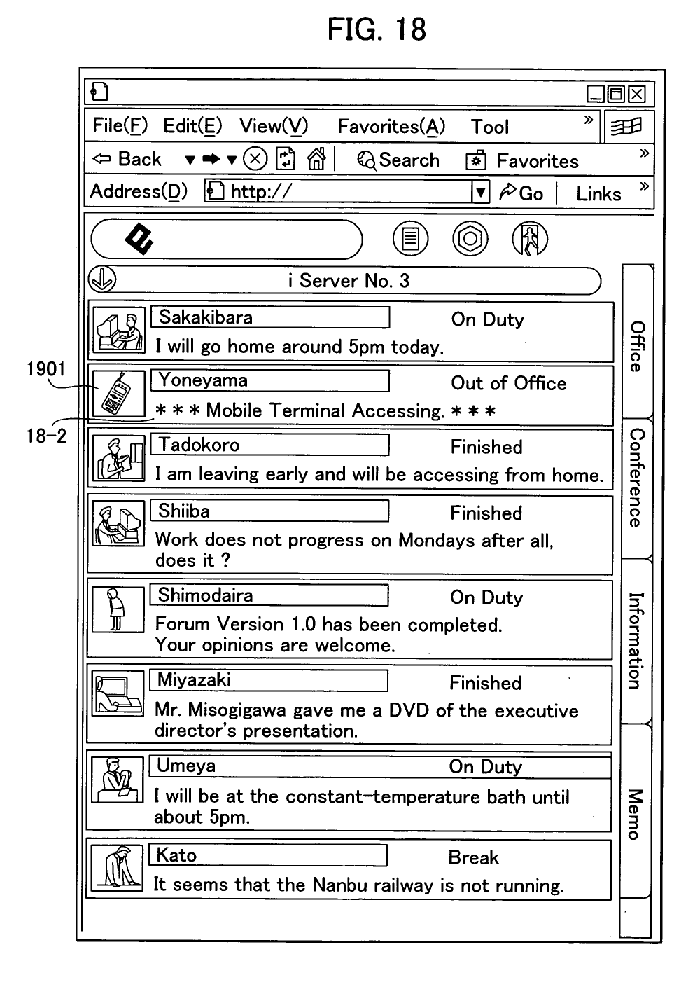

When the mobile access information containing the user ID of the connecting mobile terminal apparatus 102 is transmitted, a mobile-phone-like icon 1901 indicating that a mobile terminal is accessing to the system is displayed, as in an exemplary screen shown in FIG. 18, adjacent to an area where the name (i.e., “Yoneyama” in this case) of a user using that ID is displayed. At the same time, character information indicating that the user is accessing the system using a mobile terminal apparatus 102 is displayed in an area 18-2 where message information submitted by the user is displayed. With this arrangement, other users can know the fact that the user is connecting, using his/her mobile terminal apparatus 102, to the server apparatus 104.

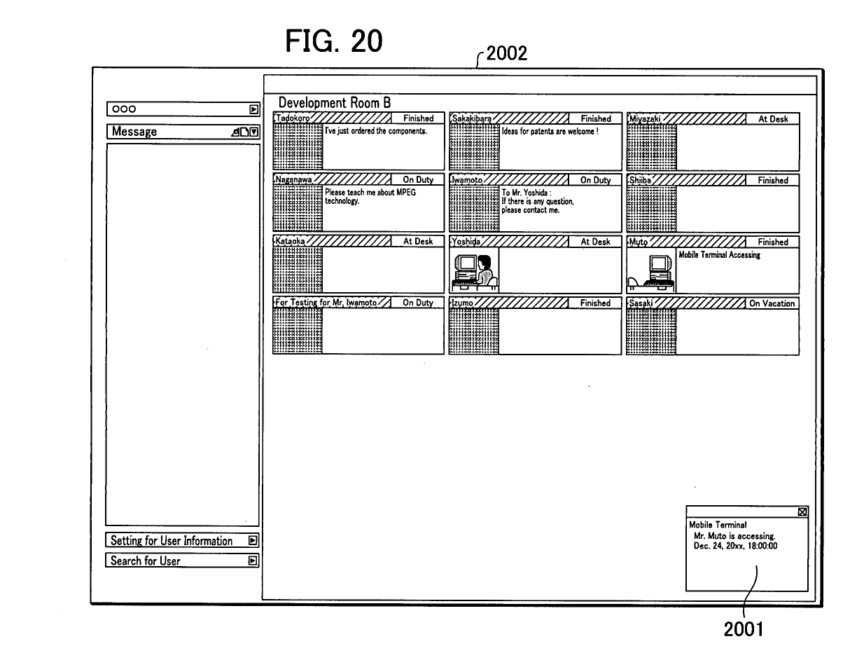

In this case, at other PC terminal apparatuses 101, a window indicating that a mobile terminal apparatus is accessing the system may be displayed in a pop-up format as indicated by reference numeral 2001 shown in FIG. 20. The pop-up window 2001 can be closed at each PC terminal apparatus 101. In the pop-up window, information including the name of a user accessing using his/her mobile terminal apparatus 102, the time of access, and the start of access (or the end of access) is displayed. The user's name displayed in the window 2001 is based on the ID information of a user accessing from the mobile terminal apparatus 102, the ID information being transmitted from the server apparatus 104. The access start time of the mobile terminal apparatus 102 is a time obtained by counting performed by a timer (not shown) built into the server apparatus 104, and is transmitted from the server apparatus 104. Additionally, information that indicates the current location of the mobile terminal apparatus 102 and that is transmitted from a base station of a telephone company may be displayed in the window 2001 of each PC terminal apparatus 101 via the server apparatus 104. This processing further allows the reciprocity policy to be maintained. When the window shown in FIG. 2 is maximized, a window like a window 2002 shown in FIG. 20 is displayed.

In this manner, for example, when a user is away from the location of his/her PC terminal apparatus for a business trip or the like, the user can know the statuses of other users in the same group by displaying them on the display section of his/her mobile terminal apparatus 102. On the other hand, in this case, when a user's PC terminal apparatus 101 having a video camera is transmitting his/her work status image, the user can also know at least any one of users in the group-information sharing system of the present embodiment is receiving and viewing his/her work status image transmitted from his/her PC terminal apparatus 101. In addition, when the ID information of the user of a connecting mobile terminal apparatus 102 is attached to the mobile access information, the user can know, specifically, who is viewing information. Even when the image distributing/sharing reciprocity between the user of a terminal apparatus that is distributing an image and the user of a terminal apparatus that is not distributing an image is out of balance, the arrangement described above can minimize a sense of insecurity and a sense of caution about being monitored, with respect to the user of the terminal apparatus that is distributing an image.

On the other hand, the fact that the user of a specific mobile terminal apparatus 102 is viewing is known to the users of the PC terminal apparatuses 101. Thus, this arrangement can advantageously control a user who is frequently viewing beyond business requirements. This can further reduce the sense of insecurity and so on of the user of a terminal apparatus that is distributing an image. This arrangement further leads to an advantage in that processing load involved in the image distribution processing control for the entire group-information sharing system is reduced.

In the above description for the second embodiment, when one user is connecting to the system from a mobile terminal apparatus 102, in order to notify other users having PC terminal apparatuses 101 of the fact, the mobile access information is provided by means of image display and means of sound output at the PC terminal apparatuses 101. However, not both of the means have to be used and only one of which may be used.

In the above description, when the users of the terminal apparatuses 101 are notified of information indicating that a mobile terminal apparatus 102 is connecting to the system, the above-noted screen indicating the information is displayed on the display section 304 of each terminal apparatus 101. Alternatively, the information may be displayed using an external device (e.g., an electronic signboard or warning lamp that is provided with an RS232 interface or USB interface and that is connected therethrough) that is connected to the system bus 308 of each terminal apparatus 101.

When the ID information of a user of a connecting mobile terminal apparatus 102 is attached to the mobile access information, speech synthesizing software may be installed on the terminal apparatus 101 so that the audio output section 310 can output synthesized natural-language voice, such as “Mr. Kato is accessing.”

A third embodiment of the present invention will now be described.

In the third embodiment, the so-called “camera-information equipped mobile phone” is used for the mobile terminal apparatus 102. The configuration of the terminal apparatuses 101 is analogous to the configuration of those in the first and second embodiments. In this group-information information sharing system, when a user is away from office, he or she can use the built-in camera of his/her mobile terminal apparatus 102 to capture his/her own image and an image of the surrounding scenery. The third embodiment of the present invention incorporates an image distribution control method in which, only when the user of the mobile terminal apparatus transmits a work status image, such as his/her own image or a surrounding-scenery image, to the server apparatus, can the user view work status images transmitted from other users' terminal apparatuses.

According to this image distribution control method, although the update frequency and the image quality are different from those of the terminal apparatuses 101 implemented by PCs, the user of the mobile terminal apparatus 102 also makes image information regarding himself/herself and the surrounding scenery available to other users, thereby ensuring a certain level of the image-transmitting/sharing reciprocity between the users. This makes it possible to alleviate a sense of insecurity and a sense of caution, which are likely to be harbored by the users of PC terminal apparatuses 101, about being monitored.

The third embodiment of the present invention will be described below in more detail with reference to the attached drawings.

The configuration of the system in the third embodiment is analogous to that in the first embodiment, except that a camera-equipped mobile terminal is used for the terminal apparatus 102 (i.e., a camera is included in the input section 302). Thus, the description of configuration of the terminal apparatus 102 is omitted.

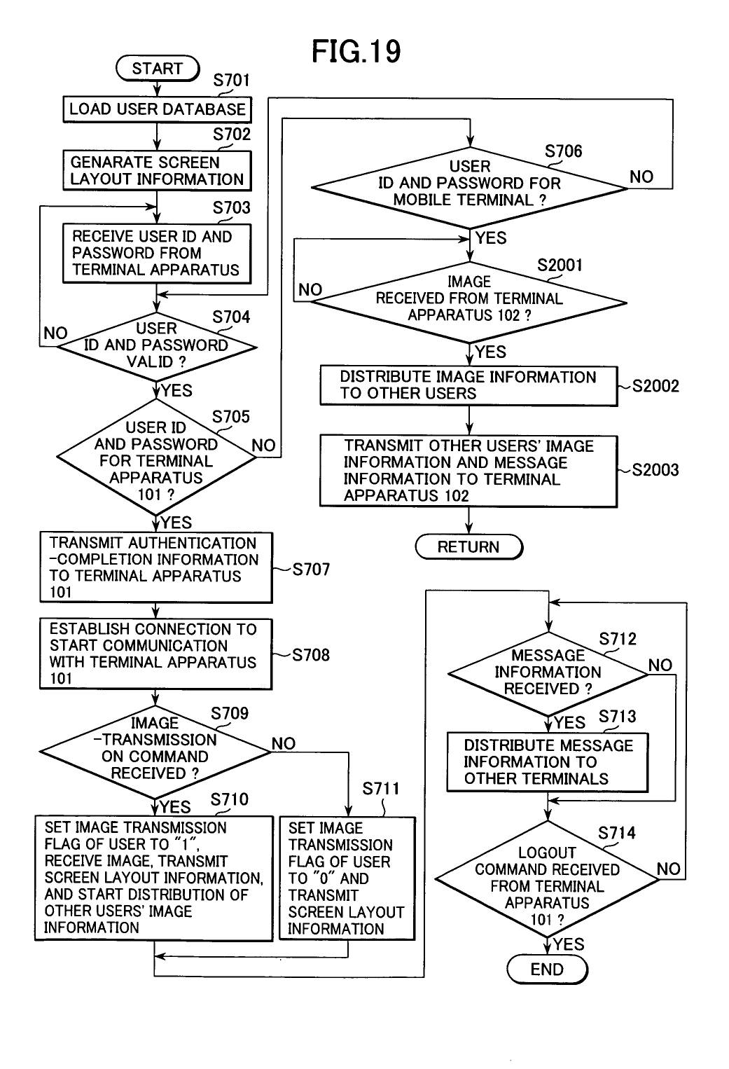

The operational flow of the image distribution control method for the system having such a configuration according to the third embodiment of the present invention will now be described with reference to a flow chart shown in FIG. 19. This flow chart shows the flow of control performed by the CPU 403 in accordance with program data stored in the memory in the server apparatus 104. Since the operation of the terminal apparatuses 101 is analogous to that in the first embodiment, the description thereof is omitted.

Since the same reference numerals in FIG. 19 as those in the flow chart of FIG. 7 represent the same processes, the descriptions thereof are omitted. For simplicity of description, it is presumed that the terminal apparatuses 101 and the server apparatus 104 are already connected to the Internet 103 using the respective communication control sections 301 and 401. Now, a description will be given starting at a control process when the terminal apparatus (a camera-equipped mobile phone) 102 is connecting to the server apparatus 104.

Thus, when the user is connecting to the system from the terminal apparatus 102, in step S706, a determination is made as to whether the user ID and password are those for connection with a terminal apparatus 102 (i.e., as to whether the user ID and password correspond to the mobile login ID and mobile password, respectively, shown in FIG. 9). When it is determined YES, the CPU 403 in the server apparatus 104 monitors information transmitted from the terminal apparatus 102, which is a camera-equipped mobile phone, in accordance with the program for a group-information sharing system server apparatus, to determine whether or not the transmitted information includes image information in step S2001.

The user who is, for example, on a business trip, uses the camera function of the camera-equipped mobile phone, i.e., the mobile terminal apparatus 102, to take his/her own image and/or surrounding-scenery image. The resulting image information is then transferred using the HTTP protocol from the mobile terminal apparatus 102 to the server apparatus 104. When it is determined by the above-described monitoring control in step S2001 that the transmitted information includes such image information from the mobile terminal apparatus 102, the server apparatus 104 immediately starts distribution of the image information to other connecting terminal apparatuses in the group in step S2002. That is, the image is processed in the same manner as that captured by the PC terminal apparatus 101.

When the user of the mobile terminal apparatus 102 transmits the image captured with the camera function to the server apparatus 104, the server apparatus 104 immediately transmits image information (i.e., work status images) and message information of other users in the group to the mobile terminal apparatus 102 in step S2003. The terminal apparatus 102 receives the information and displays a screen as shown in FIG. 8 using the web browser function included in the terminal apparatus 102.

During the process described above, when the image information is distributed to other users' PC terminal apparatuses 101 in S2002, a screen as shown in FIG. 2 is displayed on the corresponding display sections 304. In this case, an image or information indicating that a particular one of the images being displayed is obtained from the camera-equipped mobile phone is not necessarily displayed.

As described above, however, since all users transmit respective image information, this arrangement achieves image distribution control that ensures the reciprocity for both the PC terminal apparatuses 101 and the mobile terminal apparatuses 102.

In this manner, when a user wishes to know the statuses of other users in the same group while on a business trip or the like, he or she can obtain image information of the other users, in exchange for transmission of his/her image using the camera function of the mobile terminal apparatus 102. In such a case, since the image-sharing reciprocity is maintained regardless of different types of terminal apparatuses used, it is possible to minimize a sense of insecurity and a sense of caution of the users of the terminal apparatuses about being monitored.

While the camera-equipped mobile phone has been described above as an example of the mobile terminal apparatus 102, this embodiment is not limited thereto. For example, the embodiment may be applied to any other type of information terminal apparatuses, for example, various types of non-programmable mobile information apparatuses, as long as they have a video-camera image-capture function.

Additionally, an image transmitted by the camera-equipped mobile phone may be a still image or a moving image, and either type of image is displayed on the display sections of other terminal apparatuses via the server apparatus 104. In this case, although a still image can be continuously displayed, a moving image that can be continuously captured and transmitted by a camera-equipped mobile phone is typically about 10 seconds. Thus, when the moving image is played back on the display section 304 of another PC terminal apparatus 101 only once, the user often misses the moving image. Accordingly, the terminal apparatus 101 may perform control such that the moving image is repeatedly displayed rather than only once. Alternatively, out of a received moving image, the terminal apparatus 101 may perform control to extract a still image representing the moving image and to display the still image.

While the present invention has been described with reference to what are presently considered to be the preferred embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. A sharing system in which a server apparatus transmits image information of users having respective terminal apparatuses to terminal apparatuses of other users over a network and the image information is displayed on screens of the terminal apparatuses, the server apparatus comprising:
a determining unit for determining whether or not image information is received from a first terminal apparatus; and
a transmitting unit for, when the determining unit determines that image information is received from the first terminal apparatus, transmitting image information of other terminal apparatuses to a second terminal apparatus from which input of an authentication number indicating a user who is identical to a user who is logged in with the first terminal apparatus is detected.

2. A sharing system in which a server apparatus transmits image information of users having respective terminal apparatuses to terminal apparatuses of other users over a network and the image information is displayed on screens of the terminal apparatuses, the server apparatus comprising:
a storing unit for storing image information; and
a transmitting unit for transmitting image information of second terminal apparatuses to a first terminal apparatus that does not transmit image information and for, in exchange for the transmission of the image information, transmitting information indicating that the first terminal apparatus is connecting to the sharing system to the second terminal apparatuses.

3. The sharing system according to claim 2, wherein the information indicating that the first terminal apparatus is connecting to the sharing system comprises information regarding a user who is logged in with the first terminal apparatus.

4. A sharing system in which a server apparatus transmits image information of users having respective terminal apparatuses to terminal apparatuses of other users over a network and the image information is displayed on screens of the terminal apparatuses, the server apparatus comprising:
a determining unit for determining whether or not image information is transmitted from a first terminal apparatus and for determining whether or not image information is transmitted from a second terminal apparatus from which input of an authentication number indicating a user who is identical to a user who is logged in with the first terminal apparatus is detected; and
a transmitting unit for transmitting image information of terminal apparatuses other than the first and second terminal apparatuses to at least one of the first and second terminal apparatuses which is determined by the determining unit to have transmitted image information.

5. An operation processing method for a sharing system in which a server apparatus transmits image information of users having respective terminal apparatuses to terminal apparatuses of other users over a network and the image information is displayed on screens of the terminal apparatuses, the method comprising the steps of:
receiving image information from a first terminal apparatus; and
transmitting image information of other terminal apparatuses to a second terminal apparatus from which input of an authentication number indicating a user who is identical to a user who is logged in with the first terminal apparatus is detected.

6. An operation processing method for a sharing system in which a server apparatus transmits image information of users having respective terminal apparatuses to terminal apparatuses of other users over a network and the image information is displayed on screens of the terminal apparatuses, the method comprising the steps of:
storing image information; and
transmitting image information of second terminal apparatuses to a first terminal apparatus that does not transmit image-information and, in exchange for the transmission of the image information, transmitting information indicating that the first terminal apparatus is connecting to the sharing system to the second terminal apparatuses.

7. The method according to claim 6, wherein the information indicating that the first terminal apparatus is connecting to the sharing system comprises information regarding a user who is logged in with the first terminal apparatus.

8. An operation processing method for a sharing system in which a server apparatus transmits image information of users having respective terminal apparatuses to terminal apparatuses of other users over a network and the image information is displayed on screens of the terminal apparatuses, the method comprising the steps of:
determining whether or not image information is transmitted from a first terminal apparatus, and determining whether or not image information is transmitted from a second terminal apparatus from which input of an authentication number indicating a user who is identical to a user who is logged in with the first terminal apparatus is detected; and
transmitting image-information of terminal apparatuses other than the first and second terminal apparatuses to at least one of the first and second terminal apparatuses which is determined to have transmitted image information.

9. An operation processing program for a server apparatus in a sharing system in which the server apparatus transmits image information of users having respective terminal apparatuses to terminal apparatuses of other users over a network and the image information is displayed on screens of the terminal apparatuses, the program comprising:
a module for receiving image information from a first terminal apparatus; and
a transmitting module for transmitting image information of other terminal apparatuses to a second terminal apparatus from which input of an authentication number indicating a user who is identical to a user who is logged in with the first terminal apparatus is detected.

10. An operation processing program for a server apparatus in a sharing system in which the server apparatus transmits image information of users having respective terminal apparatuses to terminal apparatuses of other users over a network and the image information is displayed on screens of the terminal apparatuses, the program comprising:
a module for storing image information; and
a module for transmitting image information of second terminal apparatuses to a first terminal apparatus that does not transmit image information and for, in exchange for the transmission of the image information, transmitting information indicating that the first terminal apparatus is connecting to the sharing system to the second terminal apparatuses.

11. The program according to claim 10, wherein the information indicating that the first terminal apparatus is connecting to the sharing system comprises information regarding a user who is logged in with the first terminal apparatus.

12. An operation processing program for a server apparatus in a sharing system in which the server apparatus transmits image information of users having respective terminal apparatuses to terminal apparatuses of other users over a network and the image information is displayed on screens of the terminal apparatuses, the program comprising:
a module for determining whether or not image information is transmitted from a first terminal apparatus and for determining whether or not image information is transmitted from a second terminal apparatus from which input of an authentication number indicating a user who is identical to a user who is logged in with the first terminal apparatus is detected; and
a module for transmitting image information of terminal apparatuses other than the first and second terminal apparatuses to at least one of the first and second terminal apparatuses which is determined to have transmitted image information.

13. The sharing system according to claim 1, wherein information regarding the user who is logged in with the first terminal apparatus is displayed in pop-up windows on screens of the other terminal apparatuses.
